(19) United States
(12) Patent Application Publication
(10) Pub. No.: US 2023/0040195 A1
(43) Pub. Date: Feb. 9, 2023

(54) THREE-DIMENSIONAL POINT CLOUD IDENTIFICATION DEVICE, LEARNING DEVICE, THREE-DIMENSIONAL POINT CLOUD IDENTIFICATION METHOD, LEARNING METHOD AND PROGRAM

(71) Applicant: NIPPON TELEGRAPH AND TELEPHONE CORPORATION, Tokyo (JP)

(72) Inventors: Kana KURATA, Tokyo (JP); Yasuhiro YAO, Tokyo (JP); Shingo ANDO, Tokyo (JP); Jun SHIMAMURA, Tokyo (JP)

(73) Assignee: NIPPON TELEGRAPH AND TELEPHONE CORPORATION, Tokyo (JP)

(21) Appl. No.: 17/792,655

(22) PCT Filed: Jan. 15, 2020
(86) PCT No.: PCT/JP2020/001131

§ 371 Date: Jul. 13, 2022

(51) Int. Cl. G01S 13/89; G06K 9/00; G06N 5/04

(52) U.S. Cl. CPC G01S 13/89; G06K 9/00523; G06K 9/00536; G06N 5/04

(57) ABSTRACT

A class label of a three-dimensional point cloud can be identified with high performance. The key point choice unit 22 extracts a key point cloud 35 including three-dimensional points efficiently representing features of an object and a non-key point cloud 37. A inference unit 24 takes, as representative points, a plurality of points selected by down-sampling from each of the key point cloud 35 and the non-key point cloud 37, extracts, with respect to each of the representative points, a feature of each representative point from coordinates and the feature of the representative point and coordinates and features of neighboring points positioned near the representative point. The inference unit 24 extracts features of a plurality of new representative points from the coordinates and the features of the plurality of representative points, coordinates and features of a plurality of three-dimensional points before sampling which are the new representative points, and coordinates and features of neighboring points positioned near the new representative points. The inference unit 24 derives a class label from the coordinates and features of the plurality of representative points, or the coordinates and features of the plurality of new representative points, and outputs the class label.

### TECHNICAL FIELD

The present invention relates to a three-dimensional point cloud identification apparatus, a learning apparatus, a three-dimensional point cloud identification method, a learning method, and a program.

### BACKGROUND ART

Data of a point having three-dimensional (x, y, z) position information is called a three-dimensional point. The three-dimensional point can represent a point on a surface of an object. Data consisting of a collection of such three-dimensional points is called a three-dimensional point cloud. The point cloud is a set of n (n≥2) points, each point being identified by an identifier from 1 to n. The three-dimensional point cloud is a point on a surface of an object, is data indicating geometric information of the object and can be acquired through measurement by a distance sensor or through three-dimensional reconstruction from an image. Attribute information of a point is information other than the position information obtained at the time of measuring the point cloud, and includes, for example, an intensity value indicating a reflection intensity of the point, RGB values representing color information.

A class label of a three-dimensional point cloud indicates a type of an object represented by the three-dimensional point cloud. Such class labels include, for example, the ground, buildings, columns, cables, trees, and the like, for example, in a case that an outdoor three-dimensional point cloud is targeted.

As an identification method for identifying a class label of a three-dimensional point cloud, the following two methods are known depending on a target. A first method is a method for assigning one class label indicating a single class to a three-dimensional point cloud representing the single class (hereinafter referred to as object data) by employing an approach such as in NPL 1. Hereinafter, the first method is referred to as object identification.

A second method is a method for assigning a class label to each point in a three-dimensional point cloud including points belonging to a plurality of classes such as a street or a room (hereinafter referred to as scene data) by employing an approach such as in NPL 1. In a case that a class label different for each part is assigned, a point cloud constituting an object corresponds to scene data, even if the object is a single object. Hereinafter, the second method is referred to as semantic segmentation.

Both the object identification and the semantic segmentation can be performed by use of features extracted from the three-dimensional point cloud. It is known that an approach has high performance in which gradual feature extraction is performed by a Deep Neural Network (hereinafter referred to as DNN) having a configuration such as in NPL 1 and NPL 2 to use shape features for identification in a plurality of distance metrics. The DNN described in NPL 1 repeats selection of representative points and extraction of shape features for the representative points by X-Convolution (feature extraction mode configured by Multi-layer perceptron). Subsequently, in the case of the object identification, a down-sampling layer is provided, the representative points are decreased, and an aggregated layer of the features is provided to output a class label for the object. Furthermore, in the case of the semantic segmentation, an up-sampling layer is further provided, the representative points are increased, and a class label for each point is output.

### CITATION LIST

### Non Patent Literature

NPL 1: Y. Li, R. Bu, M. Sun, W. Wu, X. Di, B. Chen, “PointCNN: Convolution On X-Transformed Points”, pp. 828-838, 2018.
NPL 2: C. R. Qi, L. Yi, H. Su Leonidas J. Guibas, “PointNet++: Deep Hierarchical Feature Learning on Point Sets in a Metric Space”, NeurIPS, pp. 5105-5114, 2017.

### SUMMARY OF THE INVENTION

### Technical Problem

The technique disclosed in NPL 1 has the advantage that identification by use of the features in the plurality of distance metrics can be made by gradually narrowing the representative points. At this time, first, a local shape feature is assigned to each point in accordance with a shape surrounding the point. Here, in a case that an object having an even shape is used as a target of a shape represented by the input point cloud, the local shape features obtained does not change even if any representative point is selected. On the other hand, in a case that an object having a complex shape which finely changes is targeted, the local shape feature obtained changes greatly depending on which representative point is selected, and the identification performance may be reduced. For example, in a case that the representative points such as an edge portion excessively concentrate on a portion where the shape changes greatly, a complex shape which finely changes may not be captured. In a such case, the identification performance on the class label of the three-dimensional point clouds is reduced.

In NPL 1 and NPL 2, a sampling method not based on a shape around each point or a position in an object such as random sampling is used, the identification performance may be reduced due to the cause described above.

The present disclosure has been made in view of the aforementioned circumstances, and has an object to provide a three-dimensional point cloud identification apparatus, a learning apparatus, a three-dimensional point cloud identification method, a learning method, and a program that can identify a class label of a three-dimensional point cloud with high performance.

### Means for Solving the Problem

In order to achieve the above object, a three-dimensional point cloud identification apparatus according to the present disclosure is a three-dimensional point cloud identification apparatus identifying for a class label indicating a type of an object represented by a three-dimensional point cloud, the three-dimensional point cloud being composed of a plurality of three-dimensional points representing points on a surface of the object, the three-dimensional point cloud identification apparatus including: an input unit configured to receive, as inputs, coordinate data of each of the three-dimensional points constituting the three-dimensional point cloud and attribute information of each of the three-dimensional points; a key point choice unit configured to extract a key point cloud and a non-key point cloud from the three-dimensional points constituting the three-dimensional point cloud input to the input unit, the key point cloud including a plurality of key points which are three-dimensional points efficiently representing features of the object represented by the three-dimensional point cloud, the non-key point cloud including a plurality of three-dimensional points other than the plurality of key points; and an inference unit, the inference unit including a first inference information extraction unit configured to take, as representative points, a plurality of points selected by down-sampling from each of the key point cloud and the non-key point cloud extracted by the key point choice unit, and extract, with respect to each of the plurality of representative points, a feature of the representative point from coordinates and the feature of the representative point, and coordinates and features of neighboring points positioned near the representative point to output the coordinates and the features of the plurality of representative points, a second inference information extraction unit configured to extract features of a plurality of new representative points from the coordinates and the features of the plurality of representative points output from the first inference information extraction unit, coordinates and features of a plurality of three-dimensional points before the down-sampling which are the new representative points, and coordinates and features of neighboring points positioned near the new representative points to output coordinates and the features of the plurality of new representative points, and a class label inference unit configured to derive the class label from the coordinates and the features of the plurality of representative points output from the first inference information extraction unit or the coordinates and the features of the plurality of new representative points output from the second inference information extraction unit, and output the derived class label.

In order to achieve the above object, a learning apparatus according to the present disclosure is a learning apparatus for learning a model for identifying a class label indicating a type of an object represented by a three-dimensional point cloud, the three-dimensional point cloud being composed of a plurality of three-dimensional points representing points on a surface of the object, the learning apparatus including: a learning unit configured to learn a model to output a ground truth class label in a case that the three-dimensional point cloud is input to the model, the model including a first inference information extraction unit configured to extract, with respect to a plurality of representative points assigned with a ground truth class label, a feature of each representative point from coordinates and the feature of the representative point, and coordinates and features of neighboring points positioned near the representative point to output the coordinates and the features of the plurality of representative points, a second inference information extraction unit configured to extract features of a plurality of new representative points from the coordinates and the features of the plurality of representative points output from the first inference information extraction unit, coordinates and features of a plurality of three-dimensional points before the down-sampling which are the new representative points, and coordinates and features of neighboring points positioned near the new representative points to output coordinates and the features of the plurality of new representative points, and a class label inference unit deriving the class label from the coordinates and the features of the plurality of representative points output from the first inference information extraction unit or the coordinates and the features of the plurality of new representative points output from the second inference information extraction unit, and outputting the derived class label.

In order to achieve the above object, a three-dimensional point cloud identification method according to the present disclosure is a three-dimensional point cloud identification method for identifying a class label indicating a type of an object represented by a three-dimensional point cloud, the three-dimensional point cloud being composed of a plurality of three-dimensional points representing points on a surface of the object, the three-dimensional point cloud identification method including: receiving, by an input unit, as inputs, coordinate data of each of the three-dimensional points constituting the three-dimensional point cloud and attribute information of each of the three-dimensional points; by a key point choice unit, extracting, a key point cloud and a non-key point cloud from the three-dimensional points constituting the three-dimensional point cloud input to the input unit, the key point cloud including a plurality of key points which are three-dimensional points efficiently representing features of the object represented by the three-dimensional point cloud, the non-key point cloud including a plurality of three-dimensional points other than the plurality of key points; by a first inference information extraction unit, taking, as representative points, a plurality of points selected by down-sampling from each of the key point cloud and the non-key point cloud extracted by the key point choice unit, and extracting, with respect to each of the plurality of representative points, a feature of the representative point from coordinates and the feature of the representative point, and coordinates and features of neighboring points positioned near the representative point to output the coordinates and the features of the plurality of representative points; by a second inference information extraction unit, extracting features of a plurality of new representative points from the coordinates and the features of the plurality of representative points output from the first inference information extraction unit, coordinates and features of a plurality of three-dimensional points before the down-sampling which are the new representative points, and coordinates and features of neighboring points positioned near the new representative points to output coordinates and the features of the plurality of new representative points; and by a class label inference unit, deriving the class label from the coordinates and the features of the plurality of representative points output from the first inference information extraction unit or the coordinates and the features of the plurality of new representative points output from the second inference information extraction unit, and outputting the derived class label.

In order to achieve the above object, a learning method according to the present disclosure is a learning method for learning a model for identifying a class label indicating a type of an object represented by a three-dimensional point cloud, the three-dimensional point cloud being composed of a plurality of three-dimensional points representing points on a surface of the object, the learning method including: by a learning unit, learning a model to output a ground truth class label in a case that the three-dimensional point cloud is input to the model, the model including a first inference information extraction unit configured to extract, with respect to a plurality of representative points assigned with a ground truth class label, a feature of each representative point from coordinates and the feature of the representative point, and coordinates and features of neighboring points positioned near the representative point to output the coordinates and the features of the plurality of representative points, a second inference information extraction unit configured to extract features of a plurality of new representative points from the coordinates and the features of the plurality of representative points output from the first inference information extraction unit, coordinates and features of a plurality of three-dimensional points before the down-sampling which are the new representative points, and coordinates and features of neighboring points positioned near the new representative points to output coordinates and the features of the plurality of new representative points, and a class label inference unit configured to derive the class label from the coordinates and the features of the plurality of representative points output from the first inference information extraction unit or the coordinates and the features of the plurality of new representative points output from the second inference information extraction unit, and outputting the derived class label.

To achieve the above object, a program according to the present disclosure is a program for causing a computer to function as units included in the three-dimensional point cloud identification apparatus according to the present disclosure or the learning apparatus according to the present disclosure.

### Effects of the Invention

According to the present disclosure, an effect is obtained that a class label of a three-dimensional point cloud can be identified with high performance.

### BRIEF DESCRIPTION OF DRAWINGS

FIG. 1 is a block diagram illustrating a configuration of an example of a three-dimensional point cloud identification apparatus according to an embodiment.

FIG. 2 is a block diagram illustrating an example of a key point choice unit.

FIG. 3 is a block diagram illustrating an example of an inference unit.

FIG. 4 is a block diagram illustrating an example of a DNN constituting the inference unit.

FIG. 5 is a block diagram illustrating an example of a DS layer.

FIG. 6 is a block diagram illustrating an example of a US layer.

FIG. 7 is a flowchart illustrating an example of an identification processing routine in the three-dimensional point cloud identification apparatus according to the embodiment.

FIG. 8 is a block diagram illustrating a configuration of an example of a learning apparatus according to the embodiment.

FIG. 9 is a flowchart illustrating an example of a learning processing routine in the learning apparatus according to the embodiment.

FIG. 10 is a block diagram illustrating a hardware configuration of examples of the three-dimensional point cloud identification apparatus and the learning apparatus according to the embodiment.

FIG. 11 is a block diagram illustrating an example of a modification example of the key point choice unit.

### DESCRIPTION OF EMBODIMENTS

Hereinafter, an embodiment of the present disclosure will be described in detail with reference to the drawings.

Configuration of Three-Dimensional Point Cloud Identification Apparatus According to the Present Embodiment

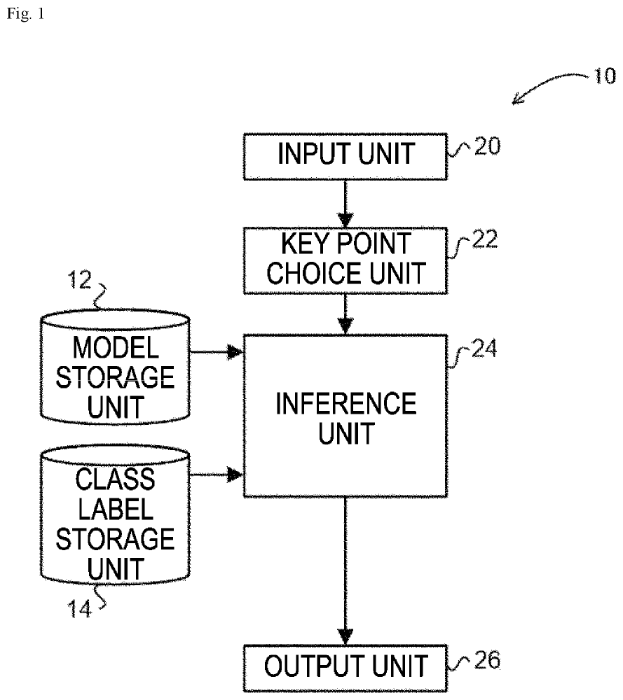

FIG. 1 is a block diagram illustrating a configuration of an example of a three-dimensional point cloud identification apparatus 10 according to the present embodiment. As illustrated in FIG. 1, the three-dimensional point cloud identification apparatus 10 according to the present embodiment includes an input unit 20, a key point choice unit 22, an inference unit 24, and an output unit 26. The three-dimensional point cloud identification apparatus 10 according to the present embodiment includes a model storage unit 12 and a class label storage unit 14.

The three-dimensional point cloud identification apparatus 10 according to the present embodiment is an apparatus for identifying a class label of a three-dimensional point cloud. As described above, the three-dimensional point cloud is data consisting of a collection of three-dimensional points each of which is data of a point having three-dimensional (x, y, z) position information. In other words, the three-dimensional point cloud is a collection of three-dimensional points each of which is data of each point constituting a point cloud composed of n (n≥2) points each of which has three-dimensional position information. Note that, in the following, for the convenience of the description, in a case that a point may be simply referred, a three-dimensional point is referred in a simplified manner. Similarly, in a case that a “point cloud” may be simply referred, a three-dimensional point cloud is referred in a simplified manner.

The three-dimensional point cloud includes two types of object data and scene data, the object data being is a three-dimensional point cloud representing a single class, the scene data being a three-dimensional point cloud including points belonging to a plurality of classes such as a street or a room. The three-dimensional point cloud identification apparatus 10 according to the present embodiment, when object data is input as a three-dimensional point cloud, outputs one class label for the input three-dimensional point cloud. On the other hand, the three-dimensional point cloud identification apparatus 10, when scene data is input as a three-dimensional point cloud, outputs one class label for each of points constituting the input three-dimensional point cloud.

The input unit 20 receives, as inputs, coordinate data of a three-dimensional point cloud (P₁, . . . , Pₙ) composed of n three-dimensional points, attribute information (C₁, . . . , Cₙ) of each of points constituting the three-dimensional point cloud, and data type representing whether the three-dimensional point cloud is the scene data or the object data. The coordinate data, attribute information (C₁, . . . , Cₙ), and data type of the three-dimensional point cloud (P₁, . . . , Pₙ) received by the input unit 20 are output to the key point choice unit 22.

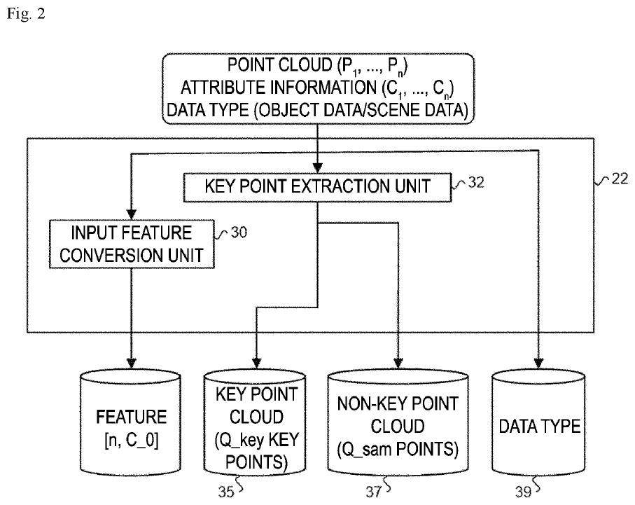

The key point choice unit 22 extracts key points to be described later from the three-dimensional point cloud (P₁, . . . , Pₙ) input from the input unit 20. FIG. 2 is a block diagram illustrating a configuration of an example of the key point choice unit 22 according to the present embodiment. As illustrated in FIG. 2, the key point choice unit 22 according to the present embodiment includes an input feature conversion unit 30 and a key point extraction unit 32.

The key point extraction unit 32 extracts and outputs Q_key (Q_key≥1) key points (key point cloud 35) from the three-dimensional point cloud input from the input unit 20. A key point is a subset of a point cloud and refers to each point included therein, the subset efficiently representing features of an object with fewer points than the original point cloud. For example, a three-dimensional point cloud in a portion where a shape of an object represented by a three-dimensional point cloud changes is used as a key point. The method for extracting the key point cloud 35 is not specifically limited, and for example, techniques described in NPL 3 and NPL 4 can be applied.
NPL 3: Y. Zhong, “Intrinsic shape signatures: A shape descriptor for 3D object recognition,” 2009 IEEE 12th International Conference on Computer Vision Workshops, ICCV Workshops, Kyoto, 2009, pp. 689-696.
NPL 4: B. Steder, R. B. Rusu, K. Konolige and W. Burgard, “Point feature extraction on 3D range scans taking into account object boundaries,” 2011 IEEE International Conference on Robotics and Automation, Shanghai, 2011, pp. 2601-2608.

The key point extraction unit 32 outputs Q_sam (n-Qkey=Q_sam≥1) three-dimensional points other than the extracted key points (non-key point cloud 37). Note that in order to enable identification of each of the key points included in the key point cloud 35, and points which are other than the key point and included in the non-key point cloud 37, the key point extraction unit 32 may assign a flag to each point for identifying the both kinds of points.

The input feature conversion unit 30 outputs features [n, C_0] for each of n points constituting the three-dimensional point cloud input from the input unit 20, by use of the attribute information input from the input unit 20. Here, C_0 represents the arbitrary number of feature dimensions, and is preset in the present embodiment.

The data type input from the input unit 20 to the key point choice unit 22 is output as a data type 39 without change.

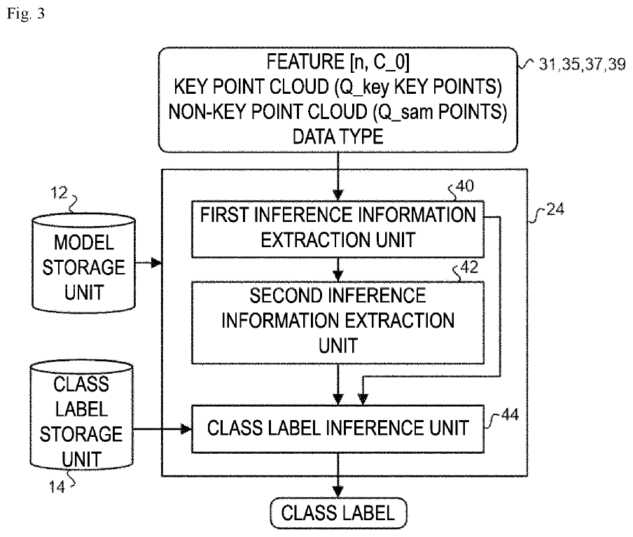

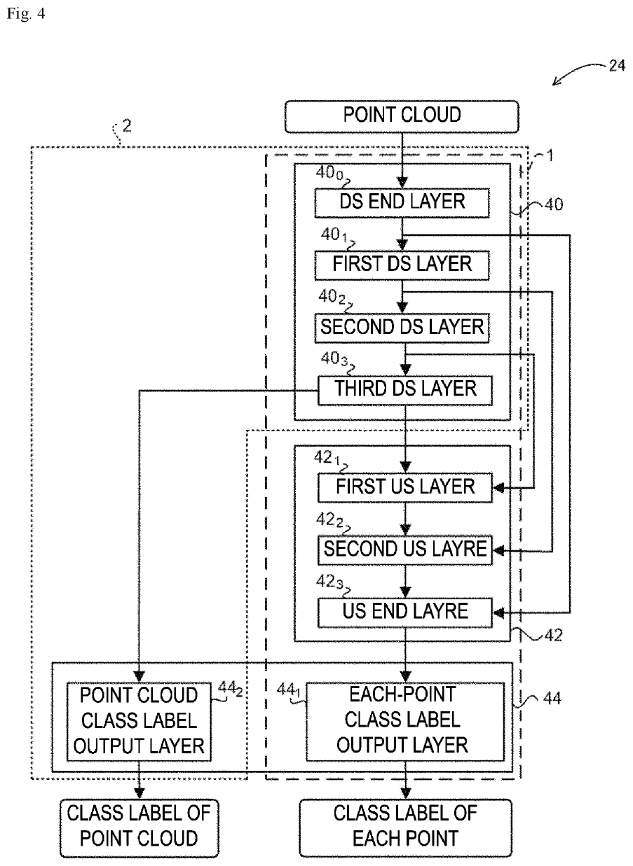

On the other hand, the inference unit 24 illustrated in FIG. 1 uses a learned model stored in the model storage unit 12 to infer a class label of the three-dimensional point cloud. FIG. 3 is a block diagram illustrating a configuration of an example of the inference unit 24 according to the present embodiment. Note that the inference unit 24 according to the present embodiment is constituted by a DNN that is the learned model stored in the model storage unit 12. FIG. 4 is a block diagram illustrating an example of the DNN constituting the inference unit 24.

As illustrated in FIGS. 3 and 4, the inference unit 24 according to the present embodiment includes a first inference information extraction unit 40, a second inference information extraction unit 42, and a class label inference unit 44.

The first inference information extraction unit 40 takes, as representative points, a plurality of points selected by down-sampling from each of the key point cloud 35 and the non-key point cloud 37 extracted by the key point choice unit 22, extracts, with respect to each of the plurality of representative points, a feature of each representative point from coordinates and the feature of the representative point, and the coordinates and features of neighboring points positioned near the representative point to output the coordinates and features of the plurality of representative points, and thus, extracts the first inference information for use in estimating the class label. As an example, the first inference information extraction unit 40 according to the present embodiment includes a DS end layer 40₀ as illustrated in FIG. 4. The coordinates of each of the representative points including the key point cloud 35 and the non-key point cloud 37, features 31 of the respective representative points, and the data types 39 are input to the DS end layer 40₀ from the key point choice unit 22, and output to subsequent layers (a first DS layer 40₁ and a US layer end 42₃).

As illustrated in FIG. 4, the first inference information extraction unit 40 includes L DS layers (a first DS layer 40₁, a second DS layer 40₂, and a third DS layer 40₃). In this way, the first inference information extraction unit 40 includes 1 to L DS layers, and a numeral number represented by L, in other words, the number of DS layers in the first inference information extraction unit 40 is variable and is one or more (L≥1). Note that the number L of DS layers is preferably larger in a case that the object of which a shape is represented by the three-dimensional point cloud is a complex object, and L=3 to 4 is more preferable. As illustrated in FIG. 4, the present embodiment illustrates a case that the number L of DS layers is equal to 3 (L=3), as an example. Hereinafter, each of L DS layers included in the first inference information extraction unit 40 is referred to as a DS layer x (1≤x≤L).

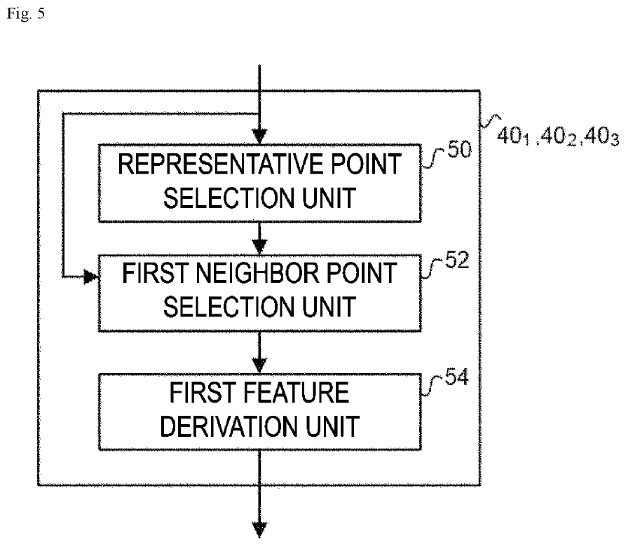

FIG. 5 is a block diagram illustrating an example of a configuration of the DS layer x (here, 1≤x≤L=3) included in the first inference information extraction unit 40. The DS layer x includes a representative point selection unit 50, a first neighboring point selection unit 52, and a first feature derivation unit 54.

Input to the representative point selection unit 50 are coordinates [m, d] and features or attribute information [m, C_(x−1)] of m representative points from the previous stage as the DS layer. Note that, in the [m, d] representing the coordinates, the former “m” represents the number of representative points. In addition, the latter “d” represents the number of dimensions of the point cloud, and d=3 applies in the case of only three-dimensional coordinates. The representative point selection unit 50 selects Q_x representative points in the DS layer by down-sampling from M representative points input in the DS layer as the previous stage. In addition, “(x−1)” represents the DS layer on the previous stage, and “C_(x−1)” represents the number of feature dimensions of the DS layer x−1 of the stage previous to the DS layer x.

Note that a method of the down-sampling is not specifically limited so long as a condition is satisfied that Q_x representative points selected by down-sampling correspond to a subset of the DS layer (x−1) and a product set of the subset and the key point cloud 35 is not an empty set. In other words, one or more three-dimensional points included in the DS layer (x−1) and from the key point cloud 35 may be sampled, and the remainder may be sampled from the non-key point cloud 37. For example, a random sampling method or the like can be applied as the down-sampling. As an example, in the down-sampling according to the present embodiment, the representative points are selected preferentially from the key point cloud 35. In other words, the down-sampling is performed so that the number of key points included in the representative points is equal to or greater than the number of points other than key point. Note that a ratio of the key points to the points other than key point included in the representative points is not specifically limited and may be random or depending on any balance corresponding to the coordinates.

Output from the representative point selection unit 50 are indexes [Q_x] of Q_x representative points selected by down-sampling. Examples of the index include a pointer and a type such as an order i (1≤i≤n) in a sequence of the three-dimensional point cloud (P₁, . . . , Pₙ) including n three-dimensional points received by the input unit 20.

The first neighboring point selection unit 52 selects K_x neighboring points positioned near Q_x representative points selected by the representative point selection unit 50, from the three-dimensional point cloud (P₁, . . . , Pₙ), and outputs coordinates of the neighboring points (relative coordinates with respect to the representative points) [Q_x, K_x, d], and features [Q_x, K_x, C_(x−1)] of the neighboring points. Note that the neighboring point selection unit 52 selects a neighboring point from the three-dimensional point cloud (P₁, . . . , Pₙ) in the first layer (DS layer 1), and selects from the representative points selected in the stage (DS layer (x−1)) previous to the current layer (DS layer x) in the second layer (DS layer 2) and subsequent layers.

Note that the method for selecting the neighboring points with respect to the representative point is not specifically limited, and for example, the K-nearest neighbor method, selecting a point included within a radius r from a representative point, or the like can be applied. The method for deriving the coordinates of the neighboring point is also not specifically limited. As an example, in the present embodiment, the relative coordinates of the neighboring point are derived according to the following procedure. First, respective coordinates are acquired from target points in accordance with the indexes of the representative point cloud and neighboring point cloud. Next, assume that coordinates of an acquired representative point Pᵢ are U_i, and coordinates of neighboring points with respect to the representative point are {S_i₀, S_i₁, . . . , S_iₖ}, relative coordinates {S_i₀−U_i, S_i₁−U_i, . . . , S_iₖ−U_i} to the representative point i are obtained by subtracting the coordinates of the representative points from the coordinates of the respective neighboring points. By performing similar processing for the respective representative points, relative coordinates of neighboring points with respect to each of the representative points can be derived.

The first feature derivation unit 54 uses a neural network to newly derive a feature [Q_x, C_x] of the representative point selected by the representative point selection unit 50. Specifically, coordinates [Q_x, d] of the representative point selected by the representative point selection unit 50, a feature [Q_x, C_(x−1)] of the selected representative point (feature at the representative point input to the representative point selection unit 50), the coordinates [Q_x, K_x, d] of the neighboring point, and the feature [Q_x, K_x, C_(x−1)] of the neighboring point are input to the neural network. As the neural network, for example, the X-Convolution described in NPL 1 and the like can be applied.

The first feature derivation unit 54 outputs the coordinates [Q_x, d] of the representative point and the feature [Q_x, C_x] output from the neural network to the next stage DS layer x.

A case of the present embodiment will be specifically described. First, a case of the first DS layer 40₁ will be described. Input to the representative point selection unit 50 in the first DS layer 40₁ are coordinates [n, 3] and features [n, C_0] of n representative points from the DS end layer 40₀. As described above, the representative point selection unit 50 newly selects Q_1 representative points (n>Q_1) from n representative points, and outputs indexes [Q_1] of the selected representative points. As described above, the first neighboring point selection unit 52 selects neighboring points of Q_1 respective representative points, and derives and outputs coordinates [Q_1, K_1, 3] of the neighboring points and features [Q_1, K_1, C_0] of the neighboring points. The first feature derivation unit 54 uses the neural network to derive new features [Q_1, C_1] for Q_1 representative points from the coordinates [Q_1, 3] of the representative points and the features [Q_1, C_0] of the representative points, and the coordinates [Q_1, K_1, 3] of the neighboring points and the features [Q_1, K_1, C_0] of the neighboring points. The first feature derivation unit 54 outputs the coordinates [Q_1, 3] of the representative points and the features [Q_1, C_1] of the representative points as a set, to the second DS layer 40₂.

Next, a case of the second DS layer 40₂ will be described. Input to the representative point selection unit 50 in the second DS layer 40₂ are the coordinates [Q_1, 3] and the features [Q_1, C_1] of Q_1 representative points from the first DS layer 40₁. As described above, the representative point selection unit 50 newly selects Q_2 representative points (Q_1>Q_2) from Q_1 representative points, and outputs indexes [Q_2] of the selected representative points. As described above, the first neighboring point selection unit 52 selects neighboring points of Q_2 respective representative points, and derives and outputs coordinates [Q_2, K_2, 3] of the neighboring points and features [Q_2, K_2, C_1] of the neighboring points. The first feature derivation unit 54 uses the neural network to derive new features [Q_2, C_2] for Q_2 representative points from the coordinates [Q_2, 3] of the representative points and the features [Q_2, C_1] of the representative points, and the coordinates [Q_2, K_2, 3] of the neighboring points and the features [Q_2, K_2, C_1] of the neighboring points. The first feature derivation unit 54 outputs the coordinates [Q_2, 3] of the representative points and the features [Q_2, C_2] of the representative points as a set, to the third DS layer 40₃.

The parameter signs “Q_1,” “Q_2,” “C_1,” “C_2,” and “K_2” in the second DS layer 40₂ are interpreted as “Q_2,” “Q_3,” “C_2,” “C_3,” and “K_3” in the next third DS layer 40₃, respectively. Note that the first feature derivation unit 54 in the third DS layer 40₃ outputs coordinates [Q_3, 3] of representative points and features [Q_3, C_3] of the representative points as a set, to the first US layer 42₁ in the second inference information extraction unit 42. In the present embodiment, the coordinates and the features of the representative points output from the third DS layer 40₃ are first inference information.

In this way, in the first inference information extraction unit 40 according to the present embodiment, the down-sampling is performed every layer of the DS layer x, and the number of representative points decreases, and the feature of each representative point is updated. For example, the number of representative points selected in the first DS layer 40₁ may be Q_1=100, the number of representative points selected in the second DS layer 40₂ may be Q_1=50, and the number of representative points selected in the third DS layer 40₃ may be Q_3=25.

On the other hand, the second inference information extraction unit 42 extracts features of a plurality of new representative points from the coordinates and the features of the plurality of representative points output from the first inference information extraction unit 40, coordinates and features of a plurality of three-dimensional points before down-sampling which are the new representative points, and coordinates and features of neighboring points positioned near the new representative points to output coordinates and the features of the plurality of new representative points, and thus, extracts the second inference information to be used for the class label. As illustrated in FIG. 4, the second inference information extraction unit 42 according to the present embodiment includes a plurality of US layers (a first US layer 42₁ and a second US layer 42₂) and a US end layer 42₃, as an example. The number of US layers included in the second inference information extraction unit 42 is a number (L−1) that is less by one than the number of DS layers included in the first inference information extraction unit 40. Accordingly, as illustrated in FIG. 4, the present embodiment illustrates a case that the number of US layers is two, as an example.

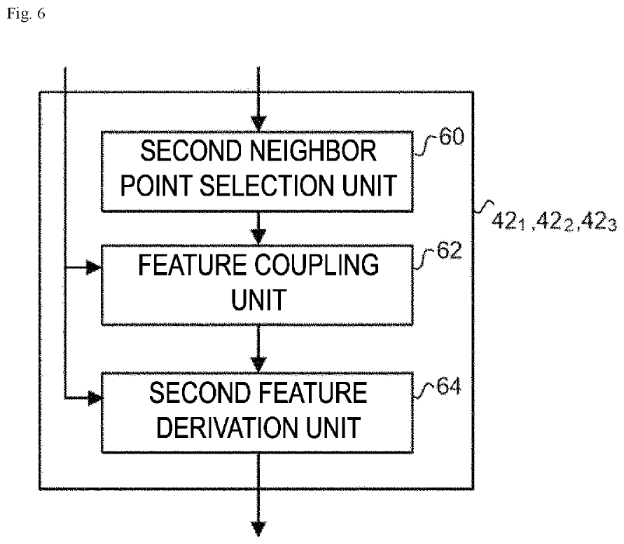

FIG. 6 is a block diagram illustrating an example of a configuration of a US layer y (1≤y≤L−1, and y=2 in the present embodiment) included in the second inference information extraction unit 42. The US layer y and the US end layer 42₃ include a second neighboring point selection unit 60, a feature coupling unit 62, and a second feature derivation unit 64.

Input to the second neighboring point selection unit 60 are the coordinates and features of the plurality of three-dimensional points before down-sampling by the DS layer x. The plurality of three-dimensional points before down-sampling are new representative points in the US layer y. The second neighboring point selection unit 60 derives and outputs coordinates and features of neighboring points positioned near the new representative points. Note that the method in which the second neighboring point selection unit 60 derives the coordinates and the feature of the neighboring points is not specifically limited, and for example, a method similar to that of the first neighboring point selection unit 52 described above can be applied.

Input to the feature coupling unit 62 are the coordinates and features of the neighboring points of the new representative points output from the second neighboring point selection unit 60 and the coordinates and features of the plurality of three-dimensional points after down-sampling by the DS layer x (representative points in the DS layer x). The feature coupling unit 62 couples both features by any means.

The second feature derivation unit 64 uses the neural network to derive features of the new representative points. Specifically, the coordinates and features of the plurality of three-dimensional points before down-sampling which are the new representative points, and the coordinates and features of the neighboring points output from the feature coupling unit 62 are input to the neural network. As the neural network, for example, the X-Convolution described in NPL 1 and the like can be applied.

The second feature derivation unit 64 sets and outputs to the subsequent stage, the coordinates of the new representative points and the features output from the neural network to the next stage.

Specifically, input to the first US layer 42₁ are the coordinates and features of the representative points in the third DS layer 40₃ output from the third DS layer 40₃ and the plurality of three-dimensional points before down-sampling in the third DS layer 40₃, i.e., the coordinates and features of the representative points in the second DS layer 40₂. The first US layer 42₁ takes, as new representative points, the plurality of three-dimensional points before down-sampling in the third DS layer 40₃. The first US layer 42₁ extracts features of the new representative points from coordinates and features of the new representative points, and coordinates and features of neighboring points positioned near the new representative points, and outputs the coordinates and features of the plurality of new representative points.

Input to the second US layer 42₂ are the coordinates and features of the representative points in the first US layer 42₁ (the new representative points describe above) output from the first US layer 42₁, and the plurality of three-dimensional points before down-sampling in the second DS layer 40₂, i.e., the coordinates and features of the representative points in the first DS layer 40₁. The second US layer 42₂ takes, as new representative points, the plurality of three-dimensional points before down-sampling in the second DS layer 40₂. The second US layer 42₂ extracts features of the new representative points from coordinates and features of the new representative points, and coordinates and features of neighboring points positioned near the new representative points, and outputs the coordinates and features of the plurality of new representative points.

Input to the US end layer 42₃ are the coordinates and features of the representative points in the second US layer 42₂ (the new representative points describe above) output from the second US layer 42₂, and the plurality of three-dimensional points before down-sampling in the first DS layer 40₁, i.e., the coordinates and features of n representative points output from the DS end layer 40₀. The US end layer 42₀ takes, as new representative points, the plurality of three-dimensional points before down-sampling in the first DS layer 40₁. The US end layer 42₀ extracts features of the new representative points from coordinates and features of the new representative points, and coordinates and features of neighboring points positioned near the new representative points, and outputs the coordinates and features of the plurality of new representative points. In the present embodiment, the coordinates and the features of the representative points output from the US end layer 42₃ are second inference information.

In this way, in the second inference information extraction unit 42 according to the present embodiment, the down-sampling is performed every layer of the US layer y, and the number of representative points increases, and the feature of each representative point is updated. For example, in a case that 25 representative points are input, the number of new representative points in the first US layer 42₁ may be 50, the number of new representative points in the second US layer 42₂ may be 50, and the number of new representative points in the US end layer 40₃ may be 100.

On the other hand, as illustrated in FIG. 4, the class label inference unit 44 according to the present embodiment includes an each-point class label output layer 44₁ and a point cloud class label output layer 44₂.

In a case that the data type 39 is scene data, the processing of the first inference information extraction unit 40 and the second inference information extraction unit 42 is performed, and the second inference information described above is input from the second inference information extraction unit 42 into the each-point class label output layer 44₁. The each-point class label output layer 44₁ refers to the class label storage unit 14, and outputs a class label indicating a type of an object for three-dimensional points constituting the scene data.

Specifically, the each-point class label output layer 44₁ derives a class label vector for each three-dimensional point from the coordinates and the feature of each representative by use of the second inference information. The class label storage unit 14 stores in advance therein association relationship between the class label vector and the class label. The each-point class label output layer 44₁ refers to the class label storage unit 14 to identify and output, for each three-dimensional point, a class label corresponding to the derived class label vector. Specifically, a class label is output per a plurality of three dimensions representing points on the surface of the object from the each-point class label output layer 44₁, in other words, a plurality of class labels are output.

In this way, in the three-dimensional point cloud identification apparatus 10 according to the present embodiment, in the case that the scene data is input, the class label for each three-dimensional point is output by a semantic segmentation unit 1 illustrated in FIG. 4 as a semantic segmentation process.

On the other hand, in a case that the data type 39 is object data, the processing only of the first inference information extraction unit 40 is performed, and the first inference information described above is input from the first inference information extraction unit 40 into the point cloud class label output layer 44₂. The point cloud class label output layer 44₂ refers to the class label storage unit 14 and outputs a class label indicating a type of a single object represented by the point cloud constituting the object data.

Specifically, the point cloud class label output layer 44₂ derives one class label vector from the coordinates and the feature of each representative point by used of the first inference information. The method for derivation is not specifically limited, and for example, a pooling layer, a fully connected layer, or the like can be applied. Note that if the number of class labels is 10, the class label vector is a 10-dimensional vector. As described above, the class label storage unit 14 stores in advance therein the association relationship between the class label vector and the class label, and thus, the point cloud class label output layer 44₂ refers to the class label storage unit 14 to identify and output a class label corresponding to one class label vector derived from each three-dimensional point. In other words, one class label is output from the point cloud class label output layer 44₂.

In this way, in the three-dimensional point cloud identification apparatus 10 according to the present embodiment, in the case that the object data is input, the class label for a single object is output by an object identification unit 2 illustrated in FIG. 4 as an object identification process.

The class label output from the inference unit 24 is input to the output unit 26 in the three-dimensional point cloud identification apparatus 10 according to the present embodiment, and the output unit 26 outputs the input class label to the outside.

Operations of Three-Dimensional Point Cloud Identification Apparatus According to the Present Embodiment

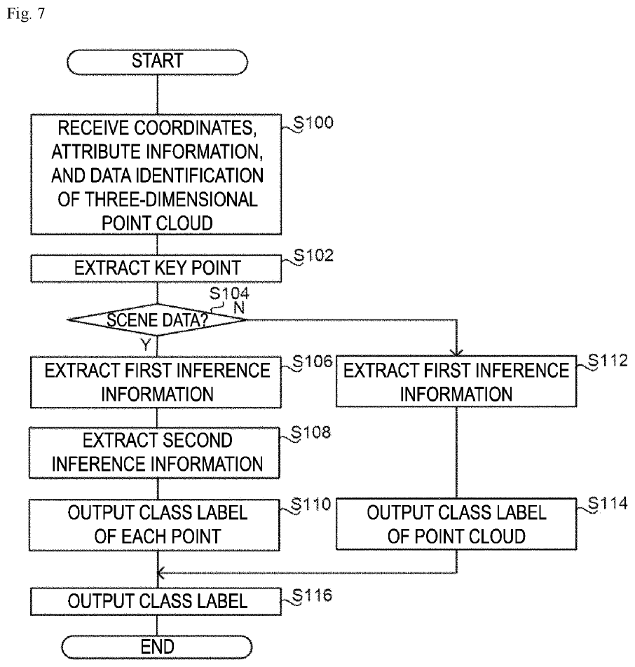

Next, operations of the three-dimensional point cloud identification apparatus 10 according to the present embodiment will be described with reference to the drawings. FIG. 7 is a flowchart illustrating an example of an identification processing routine performed in the three-dimensional point cloud identification apparatus 10 according to the present embodiment.

The identification processing routine illustrated in FIG. 7 is performed at any timing, such as a timing at which an instruction to perform the identification processing routine is received from outside the three-dimensional point cloud identification apparatus 10.

In step S100 illustrated in FIG. 7, the input unit 20 receives, as inputs, the coordinate data of the three-dimensional point cloud composed of n three-dimensional points, the attribute information of each point constituting the three-dimensional point cloud, and the data type of the three-dimensional point cloud, as described above.

In next step A102, the key point choice unit 22 extracts the key point cloud 35 from the three-dimensional point cloud input from the input unit 20, as described above. Note that the non-key point cloud 37 is also extracted in this process.

In the next step S104, the inference unit 24 determines whether the representative points (the three-dimensional point cloud) are the scene data in accordance with the data type input from the key point choice unit 22. In a case of the scene data, the determination in step S104 is a positive determination and the process goes to step S106. In this case, the semantic segmentation unit 1 described above functions.

In step S106, the first inference information extraction unit 40 extracts, as the first inference information, the coordinates and features of the representative points obtained by down-sampling, as described above. In next step S108, the second inference information extraction unit 42 extracts, as the second inference information, the coordinates and features of the representative points obtained by up-sampling, as described above. In next step S110, the each-point class label output layer 44₁ in the class label inference unit 44 identifies and outputs the class label corresponding to each of the class label vectors derived for the plurality of three-dimensional points, as described above.

On the other hand, in a case that the representative points (the three-dimensional point cloud) are not the scene data, in other words, are the object data, the determination in step S104 is a negative determination and the process goes to step S112. In this case, the object identification unit 2 describe above functions.

In step S112, the first inference information extraction unit 40 extracts, as the first inference information, the coordinates and features of the representative points obtained by down-sampling, similar to step S106 described above and as described above. In next step S114, the point cloud class label output layer 44₂ in the class label inference unit 44 identifies and outputs the class label corresponding to one class label vector derived from each three-dimensional point, as described above.

In step S116 next to step S110 or step S114, the output unit 26 outputs the class label output from the class label inference unit 44 to the outside, as described above. When the process of step S116 ends, the identification processing routine ends.

Configuration of Learning Apparatus According to the Present Embodiment

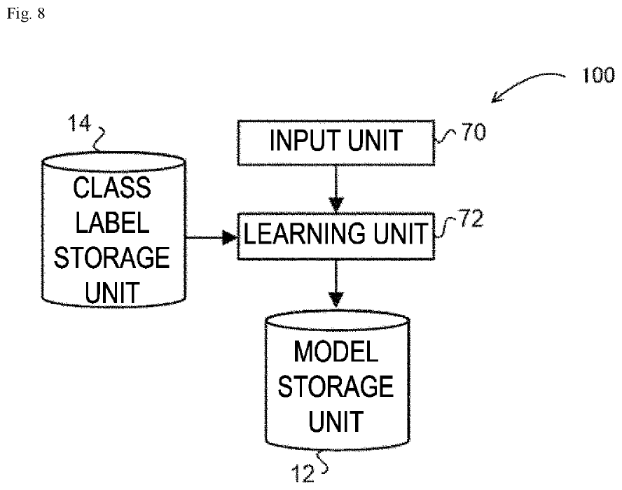

The DNN model used in the inference unit 24 described above is learned in advance and stored in the model storage unit 12. Hereinafter, a learning apparatus learning the relevant model will be described. FIG. 8 is a block diagram illustrating a configuration of an example of a learning apparatus 100 according to the present embodiment. As illustrated in FIG. 8, the learning apparatus 100 according to the present embodiment includes an input unit 70 and a learning unit 72.

The input unit 70 receives, as inputs, a plurality of representative points (three-dimensional point cloud) assigned with a ground truth class label.

The learning unit 72 inputs the plurality of representative points assigned with the ground truth positive class label input to the input unit 70 into the DNN described above, and makes the model to be learned so that a ground truth class label is output in a case that a three-dimensional point cloud is input. Note that the DNN model is preferably learned for each of the data types of the input three-dimensional point clouds, in other words, for each of the scene data and the object data. Specifically, the DNN model for configuring the semantic segmentation unit 1 is learned for the scene data. The DNN model for configuring the object identification unit 2 is learned for the object data. Note that the learning method of the model is not specifically limited, but for example, Adam may be applied as an optimization technique for the model. The learned model learned by the learning unit 72 is stored in the model storage unit 12.

Operations of Learning Apparatus According to the Present Embodiment

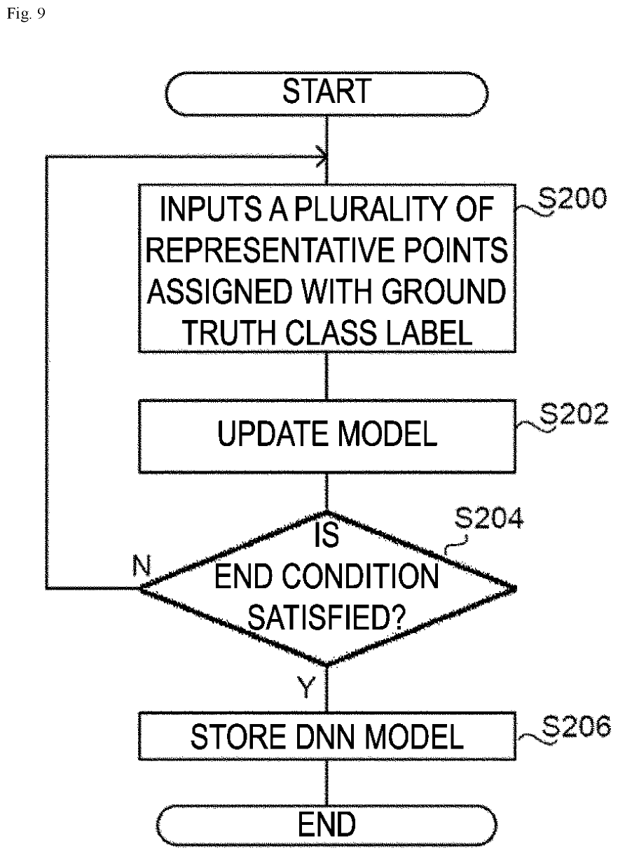

Next, operations of the learning apparatus 100 according to the present embodiment will be described with reference to the drawings. FIG. 9 is a flowchart illustrating an example of a learning processing routine performed in the learning apparatus 100 according to the present embodiment.

The learning processing routine illustrated in FIG. 9 is performed at any timing, such as, for example, a timing at which the plurality of representative points assigned with the ground truth class label are input to the input unit 70, and a timing at which an instruction to perform the learning processing routine is received from outside the learning apparatus 100.

In step S200 illustrated in FIG. 9, the learning unit 72 inputs the plurality of representative points (three-dimensional point cloud) assigned with the ground truth class label and received by the input unit 70 into to the DNN model, and in next step S202, the learning unit 72 performs deep learning of the DNN model to update the DNN model. This process updates parameters such as Q_x, K_x, and C_x described above in the DNN model, for example.

In next step S204, the learning unit 72 determines whether or not an end condition is satisfied. As an example, in the learning apparatus 100 according to the present embodiment, the number of repetitions (e.g., Z) is preset as the end condition. In this case, the learning unit 72 determines whether the process in steps S200 and S202 described above is performed Z times. In a case that the number of processes in steps S200 and S202 already performed does not yet reach Z, the determination in step S204 is a negative determination, and the process returns to step S200 to repeat the process in steps S200 and S202. On the other hand, in a case that the number of processes in steps 200 and S200 already performed reaches Z, the determination in step S204 is a positive determination and the process goes to step S206.

In step S206, the learning unit 72 stores the DNN model in the model storage unit 12. When the process of step S206 ends, the learning processing routine ends.

Hardware Configuration of Three-Dimensional Point Cloud Identification Apparatus and Learning Apparatus

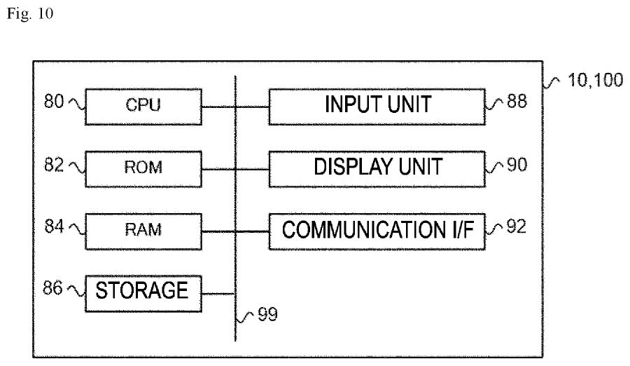

Each of the three-dimensional point cloud identification apparatus 10 and the learning apparatus 100 according to the present embodiment may be configured by the following hardware. FIG. 10 is a block diagram illustrating a hardware configuration of both the three-dimensional point cloud identification apparatus 10 and the learning apparatus 100 according to the embodiment. As illustrated in FIG. 10, each of the three-dimensional point cloud identification apparatus 10 and the learning apparatus 100 includes a central processing unit (CPU) 80, a read only memory (ROM) 82, a random access memory (RAM) 84, a storage 86, an input unit 88, a display unit 90, and a communication interface (I/F) 92. The components are communicably connected to each other through a bus 99. Note that a graphics processing unit (GPU) may be included besides the CPU 80.

The CPU 80 is a central processing unit that executes various programs and controls each component. In other words, the CPU 80 reads a program from the ROM 82 or the storage 86 and executes the program using the RAM 84 as a work area. The CPU 80 executes the programs stored in the ROM 82 or the storage 86 to function as each of the input unit 20, the key point choice unit 22, the inference unit 24, and the output unit 26 in the three-dimensional point cloud identification apparatus 10, and function as each of the input unit 70 and the learning unit 72 in the learning apparatus 100. In the present embodiment, the ROM 82 or the storage 86 stores therein a program for executing the identification processing routine or a program for executing the learning processing routine described above.

The ROM 82 stores therein various programs and various kinds of data. The RAM 84 serves as a work area that transitorily stores therein programs or data. The storage 86 includes a storage device such as a hard disk drive (HDD) or a solid state drive (SSD) and stores various programs including an operating system and various kinds of data. As an example, the storage 86 in the three-dimensional point cloud identification apparatus 10 according to the present embodiment stores therein the model storage unit 12 and the class label storage unit 14 described above.

The input unit 88 includes a pointing device such as a mouse and a keyboard, and is used to perform various inputs.

The display unit 90 is, for example, a liquid crystal display and displays various kinds of information. The display unit 90 may adopt a touch panel scheme to function as the input unit 88.

The communication interface 92 is an interface for communicating with other devices and uses standards such as, for example, Ethernet (trade name), FDDI, and Wi-Fi (trade name).

Note that in the present embodiment, the three-dimensional point cloud identification apparatus 10 and the learning apparatus 100 are described as different apparatus, but may be configured as one apparatus having the functions of the three-dimensional point cloud identification apparatus 10 and the learning apparatus 100. The storage device that stores the model storage unit 12 and the class label storage unit 14 is not specifically limited, and may be, for example, a device other than the three-dimensional point cloud identification apparatus 10 and the learning apparatus 100.

For a hardware structure of a processing unit that executes various processes of the functional units of the three-dimensional point cloud identification apparatus 10 and the learning apparatus 100 in the above-described embodiments, various processors described below can be used. The various processor described above includes, in addition to the CPU that is a general-purpose processor executing software (programs) to serves as various processing units, a programmable logic device (PLD) such as a field-programmable gate array (FPGA) the circuit configuration of which can be changed after manufacturing, a dedicated electric circuit such as an application specific integrated circuit (ASIC) that is a processor having a circuit configuration designed dedicatedly for executing the specific processing, and the like.

One processing unit may include one of these various processors or a combination of two or more processors of the same type or different types (such as, for example, a combination of a plurality of FPGAs and a combination of a CPU and an FPGA). The plurality of processing units may be composed of one processor.

In a first example of the plurality of processing units composed of one processor, as is represented by a computer such as a client and a server, one processor is constituted by a combination of one or more CPUs and software and this processor serves as the plurality of processing units. In a second example, as is represented by a system on chip (SoC) or the like, a processor is used that realizes overall functions of a system including the plurality of processing units by one IC (Integrated Circuit) chip. As described above, the various processing units are configured as hardware structures using one or more of the various processors described above.

Furthermore, as the hardware structures of such various processors, to be more specific, an electrical circuitry in combination with circuit devices such as semiconductor devices can be used.

In the embodiment described above, although an aspect is described in which the each of the program for executing the identification processing routine and the program for executing the learning processing routine is stored (installed) in the ROM 82 or the storage 86 in advance, the aspect is not limited thereto. Each of the program for executing the identification processing routine and the program for executing the learning processing routine may be provided in the form of being stored in a recording medium such as a compact disc read only memory (CD-ROM), a digital versatile disc read only memory (DVD-ROM), and a universal serial bus (USB) memory. Each of the program for executing the identification processing routine and the program for executing the learning processing routine may be in a form that is downloaded from an external apparatus via a network.

As described above, the three-dimensional point cloud identification apparatus 10 according to the present embodiment is a three-dimensional point cloud identification apparatus that identifies a class label indicating a type of an object represented by a three-dimensional point cloud composed of a plurality of three-dimensional points representing points on a surface of the object, and includes the input unit 20, the key point choice unit 22, and the inference unit 24. The input unit 20 receives, as inputs, coordinate data of each of the three-dimensional points constituting the three-dimensional point cloud and attribute information of each of the three-dimensional points. The key point choice unit 22 extracts the key point cloud 35 and the non-key point cloud 37 from the three-dimensional points constituting the three-dimensional point cloud input to the input unit 20, the key point cloud 35 including a plurality of key points which are three-dimensional points efficiently representing features of the object represented by the three-dimensional point cloud, the non-key point cloud 37 including a plurality of three-dimensional points other than the plurality of key points.

The inference unit 24 includes the first inference information extraction unit 40, the second inference information extraction unit 42, and the class label inference unit 44. The first inference information extraction unit 40 takes, as representative points, a plurality of points selected by down-sampling from each of the key point cloud 35 and the non-key point cloud 37 extracted by the key point choice unit 22, extracts, with respect to each of the plurality of representative points, a feature of each representative point from coordinates and the feature of the representative point, and coordinates and features of neighboring points positioned near the representative point to output the coordinates and features of the plurality of representative points, and then, extracts the coordinates and the features of the plurality of representative points as the first inference information. The second inference information extraction unit 42 extracts features of a plurality of new representative points from the coordinates and the features of the plurality of representative points output from the first inference information extraction unit 40, coordinates and features of a plurality of three-dimensional points before the down-sampling which are the new representative points, and coordinates and features of neighboring points positioned near the new representative points to output coordinates and the features of the plurality of new representative points as the second inference information. The class label inference unit 44 derives the class label from the coordinates and the features of the plurality of representative points as the first inference information output from the first inference information extraction unit 40 or the coordinates and the features of the plurality of new representative points as the second inference information output from the second inference information extraction unit 42.

As described above, according to the three-dimensional point cloud identification apparatus 10 according to the present embodiment, the representative points are extracted from each of the key point cloud and the non-key point cloud in the three-dimensional point cloud composed of a plurality of three-dimensional points representing points on a surface of an object, the key point cloud being three-dimensional points efficiently representing the features of the object represented by the three-dimensional point cloud. Therefore, for example, the selection of representative points does not deviate, unlike the above-described NPLs 1 and 2, and thus, the class label of the three-dimensional point cloud can be identified with high performance.

Note that the technology of the present disclosure is not limited to the present embodiment, and various modifications other than those described above can be made without departing from the gist thereof.

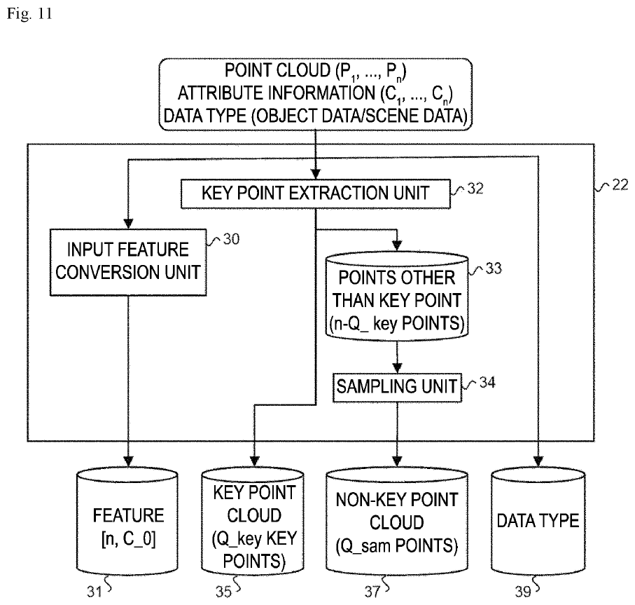

For example, the key point choice unit 22 may include a sampling unit 34 as illustrated in FIG. 11. The sampling unit 34 selects Q_sam points (n-Q_key>Q_sam≥1, Q_sam=Q−Q_key) other than the key point by sampling from n-Q_key points 33 other than the key point to output as the non-key point cloud 37. The method for selecting the non-key point cloud 37 is not specifically limited, and a random sampling method or the like can be applied, for example. Note that a sum set of the key point cloud 35 and the non-key point cloud 37 corresponds to Q representative points (representative point cloud) extracted by the key point choice unit 22. As an example, the representative point cloud according to the present embodiment includes the key points and the points other than the key point in a well-balanced manner, for example, at a desired ratio. As such, the sampling unit 34 performs sampling in consideration of the key point cloud 35 extracted by the key point extraction unit 32. For example, the sampling unit 34 performs sampling so that all points are selected with the same probability. For example, in a case that the number of points other than key point is too large as compared to the number of key points, sampling may be performed by the sampling unit 34 in this manner, and the number of points other than the key point included in the non-key point cloud 37 may be decreased.

With respect to the above embodiment, the following supplements are further disclosed.

### Supplementary Item 1

A three-dimensional point cloud identification apparatus including a memory, and
at least one processor connected to the memory,
the three-dimensional point cloud identification apparatus identifying a class label indicating a type of an object represented by a three-dimensional point cloud, the three-dimensional point cloud being composed of a plurality of three-dimensional points representing points on a surface of the object,
wherein the processor
receives, as inputs, coordinate data of each of the three-dimensional points constituting the three-dimensional point cloud and attribute information of each of the three-dimensional points,
extracts a key point cloud and a non-key point cloud from the three-dimensional points constituting the input three-dimensional point cloud, the key point cloud including a plurality of key points which are three-dimensional points efficiently representing features of the object represented by the three-dimensional point cloud, the non-key point cloud including a plurality of three-dimensional points other than the plurality of key points,
takes, as representative points, a plurality of points selected by down-sampling from each of the extracted key point cloud and non-key point cloud, and extracts, with respect to each of the plurality of representative points, a feature of the representative point from coordinates and the feature of the representative point, and coordinates and features of neighboring points positioned near the representative point to output the coordinates and the features of the plurality of representative points,
extracts features of a plurality of new representative points from the output coordinates and features of the plurality of representative points, coordinates and features of a plurality of three-dimensional points before the down-sampling which are the new representative points, and
coordinates and features of neighboring points positioned near the new representative points to output coordinates and the features of the plurality of new representative points, and
derives the class label from the output coordinates and features of the plurality of representative points or the output coordinates and features of the plurality of new representative points, and outputs the derived class label.

### Supplementary Item 2

A learning apparatus including
a memory, and
at least one processor connected to the memory,
the learning apparatus learning a model for identifying a class label indicating a type of an object represented by a three-dimensional point cloud, the three-dimensional point cloud being composed of a plurality of three-dimensional points representing points on a surface of the object,
wherein the processor
learns a model to output a ground truth class label in a case that the three-dimensional point cloud is input to the model, the model
extracting, with respect to a plurality of representative points assigned with the ground truth class label, a feature of each representative point from coordinates and the feature of the representative point, and coordinates and features of neighboring points positioned near the representative point to output the coordinates and the features of the plurality of representative points,
extracting features of a plurality of new representative points from the output coordinates and features of the plurality of representative points, coordinates and features of a plurality of three-dimensional points before the down-sampling which are the new representative points, and
coordinates and features of neighboring points positioned near the new representative points to output coordinates and the features of the plurality of new representative points, and
deriving the class label from the output coordinates and features of the plurality of representative points or the output coordinates and features of the plurality of new representative points, and outputting the derived class label.

### REFERENCE SIGNS LIST

10. Three-dimensional point cloud identification apparatus
20 Input unit
22 Key point choice unit
24 Inference unit
40 First inference information extraction unit
42 Second inference information extraction unit
44 Class label inference unit
72 Learning unit
100 Learning apparatus

1. A three-dimensional point cloud identification apparatus for identifying a class label, the three-dimensional point cloud identification apparatus comprising, a processor configured to execute a method comprising:
receiving, as a plurality of inputs, coordinate data of each of a plurality of three-dimensional points constituting a three-dimensional point cloud and attribute information of each of the plurality of three-dimensional points;
extracting a key point cloud and a non-key point cloud from the plurality of three-dimensional points including the three-dimensional point cloud, the key point cloud including a plurality of key points which are a plurality of three-dimensional points efficiently representing features of an object represented by the three-dimensional point cloud, the non-key point cloud including a plurality of three-dimensional points other than the plurality of key points;
selecting,
as a plurality of representative points, a plurality of points selected by down-sampling from each of the key point cloud and the non-key point cloud;
extracting, with respect to each of the plurality of representative points, a feature of the representative point from coordinates and the feature of the representative point, and coordinates and features of neighboring points positioned near the representative point to output the coordinates and the features of the plurality of representative points;
extracting features of a plurality of new representative points from the coordinates and the features of the plurality of representative points, coordinates and features of a plurality of three-dimensional points before the down-sampling which are the new representative points, and coordinates and features of neighboring points positioned near the new representative points to output coordinates and the features of the plurality of new representative points;
generating a class label from the coordinates and the features of the plurality of representative points or the coordinates and the features of the plurality of new representative points, wherein the class label indicates a type of an object represented by the three-dimensional point cloud, and the three-dimensional point cloud includes the plurality of three-dimensional points representing the plurality of points on a surface of the object; and
outputting the class label.

2. The three-dimensional point cloud identification apparatus according to claim 1, wherein
when the three-dimensional point cloud includes scene data representing a plurality of objects, the generating the class label further comprises generating the class label indicating the type of object for each of the plurality of three-dimensional points including the three-dimensional point cloud from the coordinates and the features of the plurality of new representative points and outputting the class label.

3. A learning apparatus for learning a model for identifying a class label indicating a type of object represented by a three-dimensional point cloud, the three-dimensional point cloud being composed of a plurality of three-dimensional points representing a plurality of points on a surface of the object, the learning apparatus comprising a processor configured to execute a method comprising:
learning a model to output a ground truth class label in a case that the three-dimensional point cloud is input to the model, the model including instructions comprising:
extracting, with respect to a plurality of representative points assigned with a ground truth class label, a feature of each of the plurality of representative points from coordinates and the feature of the representative point, and coordinates and features of neighboring points positioned near the representative point to output the coordinates and the features of the plurality of representative points,
extracting features of a plurality of new representative points from the coordinates and the features of the plurality of representative points output from the first inference information extraction unit, coordinates and features of a plurality of three-dimensional points before down-sampling which are the plurality of new representative points, and coordinates and features of a plurality of neighboring points positioned near the plurality of new representative points to output coordinates and the features of the plurality of new representative points,
generating the class label from the coordinates and the features of the plurality of representative points or the coordinates and the features of the plurality of new representative points, and
outputting the class label.

4. A computer implemented method for identifying a class label indicating a type of object represented by a three-dimensional point cloud, the three-dimensional point cloud being composed of a plurality of three-dimensional points representing a plurality of points on a surface of the object, the method comprising:
receiving, as a plurality of inputs, coordinate data of each of the plurality of three-dimensional points constituting the three-dimensional point cloud and attribute information of each of the plurality of three-dimensional points;
extracting, a key point cloud and a non-key point cloud from the plurality of three-dimensional points constituting the three-dimensional point cloud, the key point cloud including a plurality of key points which are three-dimensional points efficiently representing features of the object represented by the three-dimensional point cloud, the non-key point cloud including a plurality of three-dimensional points other than the plurality of key points;
selecting, as a plurality of representative points, a plurality of points selected by down-sampling from each of the key point cloud and the non-key point cloud;
extracting, with respect to each of the plurality of representative points, a feature of the representative point from coordinates and the feature of the representative point, and coordinates and features of neighboring points positioned near the representative point to output the coordinates and the features of the plurality of representative points;
extracting features of a plurality of new representative points from the coordinates and the features of the plurality of representative points, coordinates and features of a plurality of three-dimensional points before the down-sampling which are the new representative points, and coordinates and features of neighboring points positioned near the new representative points to output coordinates and the features of the plurality of new representative points;
generating the class label from the coordinates and the features of the plurality of representative points or the coordinates and the features of the plurality of new representative points; and
outputting the class label.

5-6. (canceled)

7. The three-dimensional point cloud identification apparatus according to claim 1, wherein,
when the three-dimensional point cloud includes object data representing a single object, the generating the class label further comprises generating the class label indicating the type of the single object represented by the three-dimensional point cloud from the coordinates and the features of the plurality of representative points and outputting the class label.

8. The three-dimensional point cloud identification apparatus according to claim 1, wherein the extracting the feature of the representative point uses a deep neural network based on input data including at least the coordinates and the feature of the representative point, and the coordinates and features of neighboring points positioned near the representative point to output the coordinates and the features of the plurality of representative points.

9. The three-dimensional point cloud identification apparatus according to claim 1, wherein the extracting features of a plurality of new representative points uses a deep neural network based on input data including the coordinates and the features of the plurality of representative points, the coordinates and features of a plurality of three-dimensional points before the down-sampling which are the new representative points, and the coordinates and features of neighboring points positioned near the new representative points to output coordinates and the features of the plurality of new representative points.

10. The learning apparatus according to claim 3, wherein
when the three-dimensional point cloud includes scene data representing a plurality of objects, the generating the class label further comprises generating the class label indicating the type of object for each of the plurality of three-dimensional points including the three-dimensional point cloud from the coordinates and the features of the plurality of new representative points and outputting the class label.

11. The learning apparatus according to claim 3, wherein
when the three-dimensional point cloud includes object data representing a single object, the generating the class label further comprises generating the class label indicating the type of the single object represented by the three-dimensional point cloud from the coordinates and the features of the plurality of representative points and outputting the class label.

12. The learning apparatus according to claim 3, wherein the extracting the feature of the representative point uses a deep neural network based on input data including at least the coordinates and the feature of the representative point, and the coordinates and features of neighboring points positioned near the representative point to output the coordinates and the features of the plurality of representative points.

13. The learning apparatus according to claim 3, wherein the extracting features of a plurality of new representative points uses a deep neural network based on input data including the coordinates and the features of the plurality of representative points, the coordinates and features of a plurality of three-dimensional points before the down-sampling which are the new representative points, and the coordinates and features of neighboring points positioned near the new representative points to output coordinates and the features of the plurality of new representative points.

14. The computer implemented method according to claim 4, wherein,
when the three-dimensional point cloud includes scene data representing a plurality of objects, the generating the class label further comprises generating the class label indicating the type of object for each of the plurality of three-dimensional points including the three-dimensional point cloud from the coordinates and the features of the plurality of new representative points and outputting the class label.

15. The computer implemented method according to claim 4, wherein,
when the three-dimensional point cloud includes object data representing a single object, the generating the class label further comprises generating the class label indicating the type of the single object represented by the three-dimensional point cloud from the coordinates and the features of the plurality of representative points and outputting the class label.

16. The computer implemented method according to claim 4, wherein the extracting the feature of the representative point uses a deep neural network based on input data including at least the coordinates and the feature of the representative point, and the coordinates and features of neighboring points positioned near the representative point to output the coordinates and the features of the plurality of representative points.

17. The computer implemented method according to claim 4, wherein the extracting features of a plurality of new representative points uses a deep neural network based on input data including the coordinates and the features of the plurality of representative points, the coordinates and features of a plurality of three-dimensional points before the down-sampling which are the new representative points, and the coordinates and features of neighboring points positioned near the new representative points to output coordinates and the features of the plurality of new representative points.
